(19) United States
(12) Patent Application Publication
(10) Pub. No.: US 2026/0249455 A1
(43) Pub. Date: Aug. 27, 2026

(54) SYSTEM AND METHOD FOR CONTROLLING AN AUTONOMOUS DEVICE

(71) Applicant: Mentee Robotics Ltd., Herzliya (IL)

(72) Inventors: Shir GUR, Herzliya (IL); Tom SHENKAR, Herzliya (IL); Lior WOLF, Herzliya (IL); Shai SHALEV-SWARTZ, Herzliya (IL)

(21) Appl. No.: 19/547,793

(22) Filed: Feb. 24, 2026

Related U.S. Application Data
(60) Provisional application No. 63/762,614, filed on Feb. 24, 2025.

(51) Int. Cl. B25J 9/16; G05B 13/02; G06N 3/008

(52) U.S. Cl. CPC B25J 9/163; G05B 13/0265; G06N 3/008

(57) ABSTRACT

According to various embodiments a data processing system is provided, comprising one or more processors configured to control an autonomous device to perform a task, wherein the device has a plurality of parts whose movement can be controlled by actuators, by generating, by a motion machine-learning model, from a movement trajectory of each part of a proper subset of the plurality of parts, motion information specifying a movement trajectory of each part of the plurality of parts; and generating, by a tracking machine-learning model, actuator control signals to control the robot device to follow, with each of its parts, the movement trajectory of the part specified by the motion information.

### CROSS-REFERENCE TO RELATED APPLICATION

This application claims priority to U.S. Provisional Application Ser. No. 63/762,614, which was filed Feb. 24, 2025, and is incorporated herein by reference in its entirety.

### TECHNICAL FIELD

Various aspects of this disclosure generally relate to systems and methods for controlling an autonomous device.

### BACKGROUND

Controlling a complex autonomous device having a high number of (e.g., body) parts such as a humanoid robot to perform a task requires taking into account the relation between the various parts.

For example, controlling a humanoid robot to take an object from a shelf does not only require controlling the arm of the robot, but also controlling other parts of the body (e.g., their relative poses), for example to prevent the robot losing balance.

Machine-learning models are powerful tools for providing such control functionality for autonomous devices. However, training a complex autonomous device to be capable of performing multiple tasks remains challenging.

Accordingly, approaches for controlling autonomous devices which allow an effective training and robust control for multiple tasks are desirable.

### BRIEF DESCRIPTION OF THE DRAWINGS

In the drawings, identical reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 illustrates a human taking an object from a shelf.

FIG. 2 illustrates a humanoid robot performing the same task of taking an object from a shelf.

FIG. 3 illustrates a control flow according to an embodiment.

FIG. 4 illustrates a text-vision-action model according to an embodiment.

FIG. 5 illustrates an operation of a first sub-model of a task foundation model according to an embodiment.

FIG. 6 illustrates an operation of a second sub-model of a task foundation model according to an embodiment.

FIG. 7 illustrates an operation of a tracking model according to an embodiment.

FIG. 8 illustrates an embodiment where a movement guideline model and a motion model are integrated together in a model.

FIG. 9 shows a data processing system according to an embodiment.

FIG. 10 shows a flow diagram illustrating a method for controlling an autonomous device according to an embodiment.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the Examples expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the examples, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Humanoid robots are being developed to perform task performed by humans.

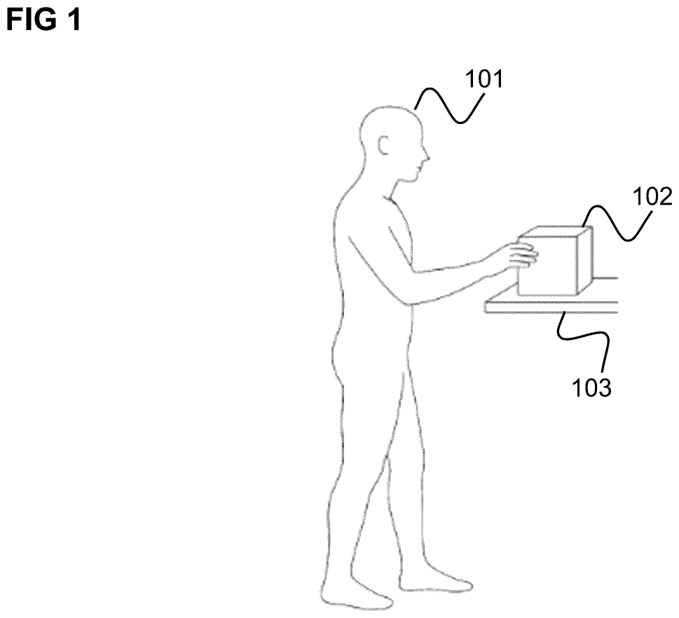

FIG. 1 illustrates a human 101 taking an object 102 from a shelf 103. For example, the human 101 performs this (manual) task of picking up the object 102 for cooking.

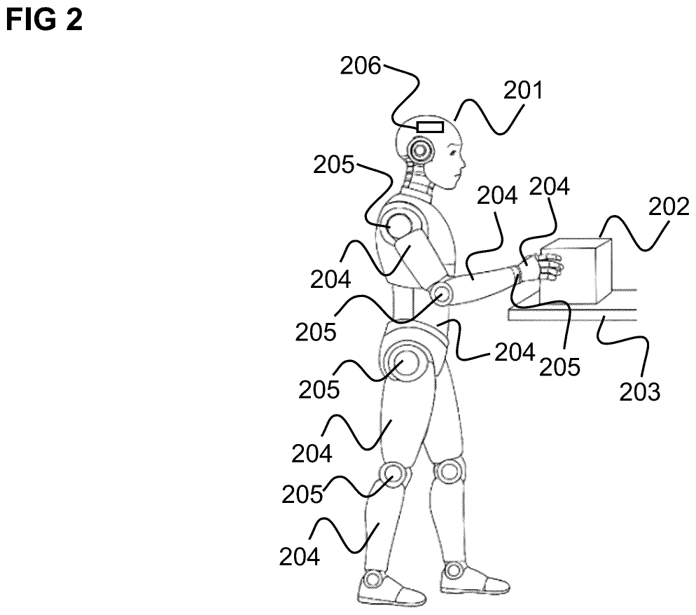

FIG. 2 illustrates a humanoid robot 201 performing the same task of taking an object 202 from a shelf 203.

The humanoid robot 201 has a plurality of body parts (or rigid body segments) 204 (e.g., including limbs (arms, legs, fingers, finger tips . . . ) as well as its torso). The humanoid robot 201 can be seen to replicate a human 100. The poses of the body parts 204 can be controlled by actuators 205 (typically motors), typically located at joints between the body parts 204. For performing the task, a controller 206, typically located within the humanoid robot 201, needs to control the actuators 205 accordingly. It should be noted that this does not only require controlling the actuators 205 such that the robot's hand (which may be seen as its end-effector) moves in a suitable manner (e.g. avoiding the shelf and getting in a suitable correct grasping position) but also controlling the actuators 205 to avoid, for example, that the robot 201 falls (which may be simple in the illustrated exemplary task but much harder in other cases, e.g. when the robot 201 needs to duck for taking a dish from an oven).

Typically, controlling a robot 201 to perform a task (in a given control scene, e.g., including a set of one or more objects 202) includes high-level task planning (e.g., determining a trajectory for the robot's hand) and low-level motor control (e.g., controlling all the actuators 205 such that the hand follows the determined (planned) trajectory without the robot 201 falling).

The controller 206 may perform control according to a control policy which is for example implemented (or represented) by a machine-learning (ML) model (e.g., stored in a memory of the robot 201).

Conventional approaches to robot control often struggle to bridge the gap between high-level task planning and low-level motor control. Existing solutions typically rely on either predetermined motion primitives or end-to-end learning, both of which have significant limitations in terms of generalization and precision. Additionally, while large language models have shown promise in task planning, effectively translating their outputs into physical robot actions remains challenging.

In the world of manual tasks, one can distinguish for development purposes between multiple classes of tasks:
(i) pick and place of small objects,
(ii) pick and place of large objects,
(iii) other tasks of low complexity,
(iv) other tasks of higher complexity.

The first two classes are specific cases that are amenable to generic solutions. The same control policy can be used to pick a ball, a cube, a glass, etc. The distinction between the last two classes, i.e., the level of complexity, is based on the number of different steps in each task, its duration, the level of accuracy required in performing it, etc. Ultimately, it is linked to the amount and type of training data required to train the ML model and the capacity of the ML model.

Three lines of technology may be considered for controlling a robot 201 to perform manual tasks. These are not mutually exclusive, but the delineation helps in understanding the gamut of available tools.

The first line of methods is a mechanistic approach, which is best exemplified in the pick-and-place task. A reasonable approach for picking small items is to find the point cloud of each object, compute the boundaries of the object, and have an end-effector (a gripper, e.g., robot hand, in this case) close around the object. This is done by computing a 3D path for the end-effector (EE) from an initial position to a suitable grasp position, wherein the gripper is opened at the end of the motion to be closed to close around the object.

The second line of methods is to learn a control policy by reinforcement learning (RL) to optimize a suitable reward using a 3D model of the respective control scene. Three types of rewards can be distinguished: (1) rewarding the main goal of the task, (2) auxiliary rewards that help achieve the main goal in complex tasks and also define preferences for the way the task is performed, and the specific auxiliary loss subtype (3) imitation type of rewards that mimic sample execution or some aspects of it, e.g., the path of the 3D objects.

The third type of methods is imitation learning, in which the ML model learns, through supervised learning or RL, to repeat the task as it was performed in a training set. This type of methods is most readily feasible when the data is collected through teleoperation using the robot's view, and when having complete information on the robot's state, but can be generalized to also mimic, for example, a human performing the task, who is captured from the side.

According to various embodiments, a framework is provided that enables using imitation learning to train a foundation model (e.g., as part of the ML model implemented by a robot controller, such as controller 206). Simulated worlds and tasks may be used to collect at least some of the training data. To create the sensorimotor information that is required for imitation learning, a simulated robot may use a learned RL policy (i.e., a control policy trained by reinforcement learning) to complete the task. Sensorimotor information that is gathered from the robot operating according to the RL policy may then be used for imitation learning. The training using RL may include automatic reward shaping, which is important to reduce the time it takes to learn a new RL task. This may be useful for other forms of task performance, including a mechanistic approach to pick and place.

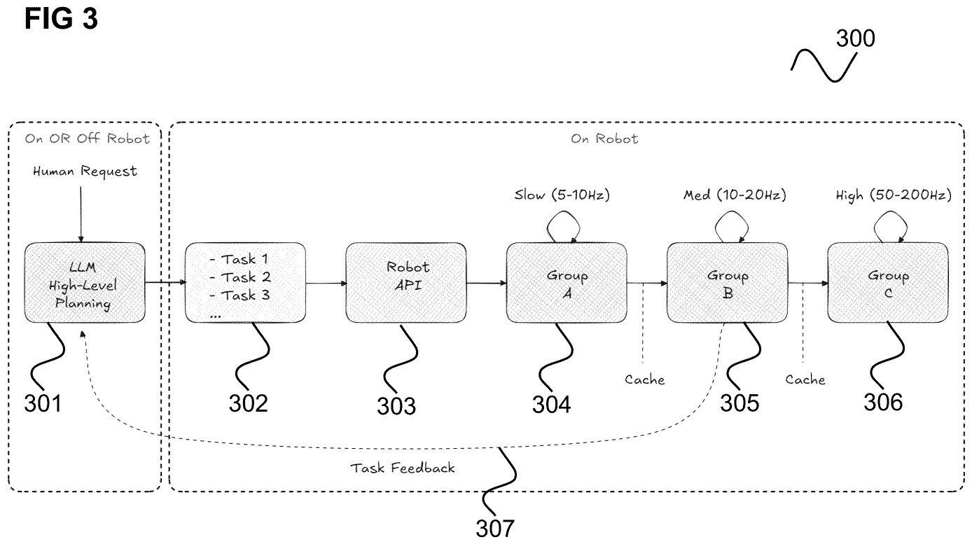

FIG. 3 illustrates a control flow according to an embodiment.

The control (execution) flow is performed by a control system which implements an ML model 300 and which includes °a high-level planning layer 301 which utilizes one or more language models for task interpretation and decomposition. For example, it comprises a high-level language model (LLM planner) for (high-level) task planning and decomposition of a task into sub-tasks 302 (e.g., in a suitable representation for the robot's API (Application Programming Interface) 303.
a task foundation model for generating (e.g., robot-agnostic) motion trajectories. It includes a “Group A” 304 of ML model components (e.g., layers or transformer blocks) and a “Group B” 305 of ML model components (e.g., layers or transformer blocks) 305. Each motion trajectory (for a specific body part 204) is for example specified as a RBP (Rigid Body Property) trajectory, i.e., as a sequence of Rigid Body Properties (or rigid body poses), wherein, for example, each body part 204 (or “rigid body”) is represented by a respective representative point of the body part 204 (e.g., center point of the body part 204).
A robot-specific (motion) tracking model for translating (e.g., RBP) trajectories into precise actuator commands (executed by the robot's actuators 205, e.g., motors) including “Group C” 306 of ML model components (e.g., layers or transformer blocks). It should be noted that, according to various embodiments, a tracking model which controls a robot 201 to follow one or more trajectories (for one or more body parts 204), i.e., which translates one or more trajectories into actuator control signals (e.g. motor commands) may be also be denoted as imitation model in the sense that the resulting movement of the robot imitates, e.g., human movement.

These may be seen as three (primary) layers operating at different levels of abstraction which may operate at different frequencies, i.e., providing results in different time intervals. In other words, the various (sub-)models of the ML model may generate outputs at different rates.

For example, as indicated in FIG. 3, the task foundation model may operate at a lower frequency (e.g., 1-20 Hz, e.g. 2 Hz where Group A and Group B may operate at different frequencies, e.g. Group A at 5-10 Hz and Group B at 10-20 Hz) and the robot-specific (motion) tracking model may operate at a higher frequency (e.g. within a range of 50-200 Hz or 40-400 Hz, e.g. 60 Hz). The LLM may for example (e.g., only) operate on demand, e.g., when triggered by a user prompt or feedback 307 from the task foundation model (e.g., Group B).

An output from a model (e.g., Group A) may for example be stored in a cache from where it may be retrieved by another model (e.g., Group B) which processes that output.

For example, to implement the above three components, the control system has a hierarchical transformer-based architecture for controlling a robot device (e.g., a humanoid robot 201) through a combination of high-level task planning and low-level motion control, e.g., by combining (or integrating) a language model, vision processing and (precise) motion control. This for example enables sophisticated robot behavior.

The high-level planning layer 301 for example comprises a large language model (LLM) and/or a vision-language model (VLM) for task interpretation. It performs task decomposition into sub-tasks 302 and uses the robot API interface 303 for command execution.

For example, the high-level planning layer 301 utilizes a large language model or vision-language model to:
Process human requests and commands
Decompose complex tasks into executable sub-tasks
Interface with the robot API 303 for task execution
Maintain task context and progress tracking

The decomposition of a task into sub-tasks 302 is for example based on receiving a human request for a task and using a prompt that decomposes the task into sub-tasks 302 based on the given robot API 303. For example, the LLM or VLM may be prompted to convert a textual description of the task to a script that executes a limited set of API commands.

The robot API 303 exposes capabilities including
Object detection and localization (e.g., the object 202 but also other objects in the environment, in particular obstacles, such as the shelf 203)
Navigation commands
Foundation model task execution
Environment interaction primitives

So, the specification of the sub-tasks 302 (e.g., in form of text and/or video) is supplied via the robot API 303 to Group A of the task foundation model and the task foundation model 304, 305 and the (motion) tracking model 306 processes the sub-task descriptions to generate actuator control signals to make the robot 201 perform the specified sub-tasks.

The task foundation model 304, 305 and the (motion) tracking model 306 are for example part of (or form) a text-vision-action model.

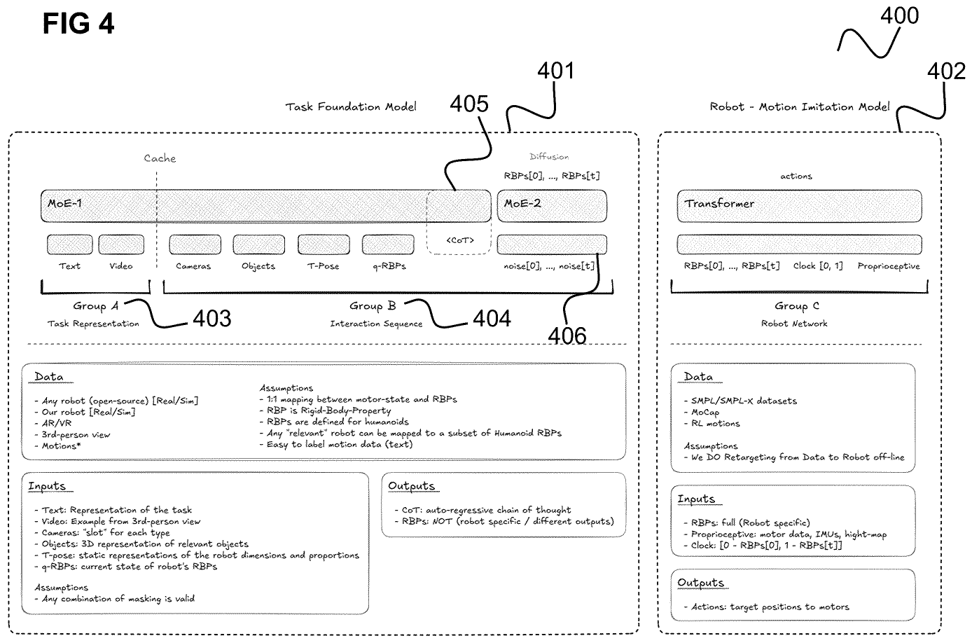

FIG. 4 illustrates a text-vision-action model 400 according to an embodiment.

The model 400 includes two sub-models: a task foundation model 401, which is robot agnostic, and a motion model 402. As described above, the task foundation model 401 includes a Group A (or part A) 403 and a Group B (or part B) 404.

The task foundation model 401 for example operates at a lower frequency than the high-level planning layer 301 (i.e., the LLM or VLM). Group A performs task representation and Group B interaction sequence generation and rigid body property (RBP) trajectory generation.

In the present embodiment, Group A handles static inputs and Group B runs in a repeated execution loop (repeatedly and, for example, at a higher rate than Group A). This means that the task foundation model 401 may be separated in two sub-models (Group A and Group B), resulting in three (sub-)models (Group A, Group B, Group C). Any one of these sub-models may have or include a transformer architecture. In particular, any one of these sub-models may have or include a neural network.

The three (sub-)models (Group A, Group B, Group C) according to one embodiment are described in the following.

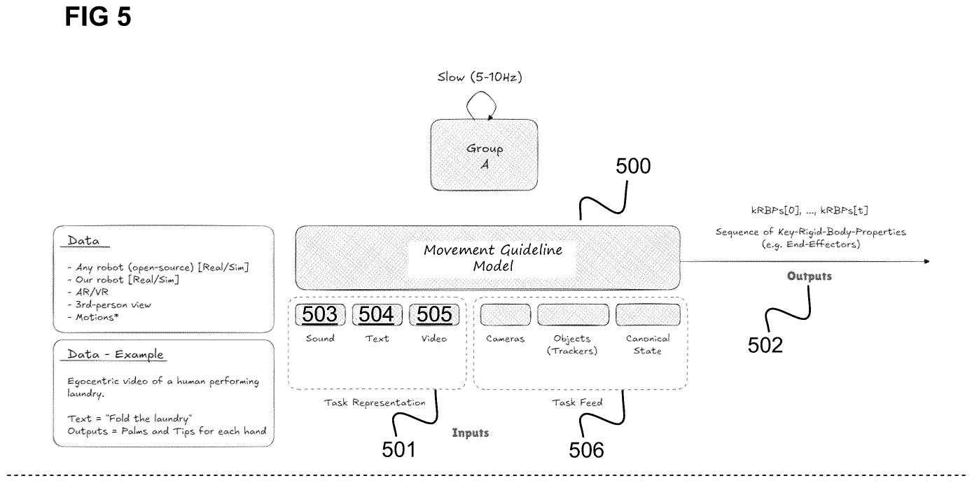

FIG. 5 illustrates an operation of a first sub-model 500 of a task foundation model according to an embodiment (Group A).

The first sub-model 500 (Group A) receives a task representation 501 for each sub-task 302 and generates an output 502 including a trajectory for a proper subset of the set of body parts 204 of the robot 201. This sub-set are for example denoted as key body parts So, the output of the first sub-model 500 is a sequence kRBPs[0], . . . , kRBPs[t], wherein each kRBPs[i] includes a pose for each key body part for the ith control time. The key body parts may depend on the task. For example, when the robot 201 should pick up an object 202 from a shelf 203, the key body part may include the palm and/or multiple fingers and e.g., the torso (to specify a general positioning of the robot 201).

So, since the first sub-model 500 only outputs trajectories for the key body parts, this may be seen as a sparse representation of the motion of the robot 201 to perform the task. As described below, this sparse representation is converted to a more complete or less sparse (e.g., “full”) representation of the motion of the robot 201 (i.e., a full set of body part trajectories) to perform the task by Group B. It should be noted that a key body part does not have to be a fixed point of a certain body part 204. Trajectories of other points representing a movement, possibly a joint movement of one or more body parts 204 may also be used, e.g., a trajectory for a center of mass of the robot 201 (which, again, may give information to the second sub-model 305 on how all body parts 204 should move). Moreover, a trajectory does not have to be associated with a unique body part but can be associated with a set or either one of a set (i.e., there may be a degree of freedom which body part follows the trajectory). For example, to push a button, it is sufficient if one fingertip follows a specified trajectory but this can be done by either one of multiple fingers (in particular by a finger of either hand).

The first sub-model 500 for example comprises a text encoder 504 for command processing and a video encoder 505 for demonstration processing.

The text encoder 504 processes descriptions of the (sub-)task to perform. In addition or in alternative, a sound encoder 503 may process an audio description of the sub-task (or additional information given by sound, e.g., a spoken description given by a user). The video encoder 505 can receive a video from the robot point of view, or a side view, depicting, for example, a person performing the task. This way a person can mentor the robot 201 how to perform a task.

The first sub-model 500 may also receive information 506 about the control scene, e.g., camera images (e.g., provided by one or more cameras of the robot 201), information about presence and or poses of objects in the control scene as well as information about a canonical state of the robot 201. The canonical state is the state of the (e.g. humanoid) robot or human at every time point. It is canonical in the sense that it is specified in terms of a model such as SMPL-X (or whatever abstract domain is used for Group A and Group B) and not in terms of the robot joint or part location.

So, the robot API 303 can run Group A of the task foundation model 401 using text, sound and/or video input as needed. It may also have commands for recording video demonstrations when asked to record these, and for retrieving relevant demonstrations from a dataset of video demonstrations.

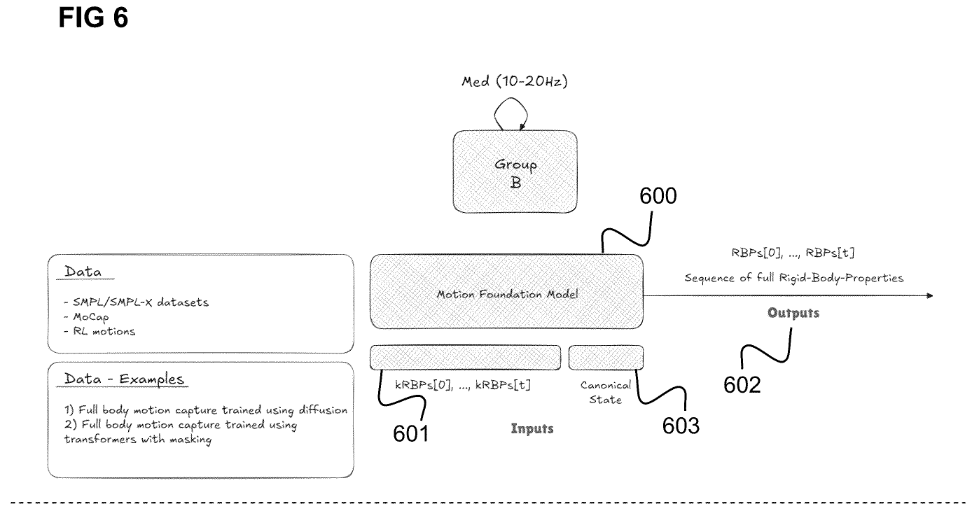

FIG. 6 illustrates an operation of a second sub-model 600 (here denoted as motion foundation model) of a task foundation model according to an embodiment (Group B).

The second sub-model 600 (Group B) generates a full set of trajectories as output 602, i.e., a trajectory for each of the set of body parts 204, from the sparse set of trajectories 601 including a trajectory for each key body part, output by the first sub-model 500. So, while the sparse set of trajectories may be seen as a movement guideline for the robot 201, the full set of trajectories may be seen as specifying the complete motion.

Accordingly, the first sub-model 500 (“Group A”) is also denoted as movement guideline (or movement guideline foundation) model and the second sub-model 600 is also denoted as motion (or motion foundation) model. Both may be machine-learning models. The motion (ML) model 600 may also be seen as motion imitation (ML) model.

As further input, the second sub-model 600 may receive information about a canonical state 603 of the robot 201.

For example, the second sub-model 600 generates robot-agnostic trajectories specified in terms of Rigid Body Properties (RBPs), which include the components below or a subset thereof:
Position and orientation information, e.g., of each body part 204
Velocity and acceleration parameters, e.g., of each body part 204
Interaction force specifications, e.g., contact forces between body parts 204 and the environment (e.g., an object 202, 203 in the control scene), internal forces between body parts 204 and environmental interaction forces (such as friction, e.g., of the object 202)
Temporal sequence information, e.g., a pose of each body part 204 over time

The second sub-model 600 for example has one or more of the following features:
a transformer architecture for sequence generation (e.g., pose sequence, i.e., trajectory generation, for each body part 204, or at least a latent representation thereof)
Camera input processing (to get information about the control scene)
Object representation processing (of representations (e.g., 3D models) of objects in the control scene, e.g., of the object 202 or the shelf 203)
usage of a T-Pose representation (of the robot 201)
Current RBP (q-RBP) state processing (for taking into account a current state of the robot 201, e.g., in terms of poses of the body parts 204)
Diffusion-based trajectory generation (for the body parts 204), e.g., applying noise 406 to trajectories (or trajectory placeholders) for all body parts and denoising the resulting noisy trajectories
Chain of Thought (CoT) reasoning component 405

The second sub-model 600 tokenizes each of its inputs using a suitable encoder that can be a frozen (e.g., pre-trained and then kept unchanged) off-the-shelf encoder (e.g., an image encoder of a Vision Language Model for camera images, for object representations STL (Standard Triangle Language or Standard Tessellation Language) and other encoders, etc.), a specially trained one, or a finetuned version of an existing encoder.

The second sub-model 600 may for example process camera images provided by the robot's main cameras as well as possible wrist cameras. The exact configuration changes from one robot to the next and the task foundation model 401 is for example robot agnostic allowing it to support multiple configurations.

It should be noted that the cameras can be color cameras (e.g., RGB) or image and depth (e.g., RGBD) cameras.

Object representation processing includes encoding (by an object representation encoder) of representations of relevant scene objects, including their geometry and position. Relevant scene objects are for example determined by the LLM of their high-level planning layer and their update (e.g., of their locations, orientations or poses) may be part of a repeated call to group B (e.g., one or more tokenizers of group B).

The set of objects can be described, for example, as {Eᵢ, Pᵢ} where Ei is an embedding (e.g., latent representation) of each object and Pi is its 6-DOF (degree of freedom) position.

Since the robot configuration may change between different training and test samples, configuration information about the robot 201 may be passed to task foundation model 401. Although this is placed under Group B this is typically a static description and can be moved to (i.e., processed by) “group A”. This description includes the general structure of the robot (one arm, two arms, etc.), the length of the links of the limbs, the position and type of cameras, and other parameters that determine the structure of the robot 201.

The q-RBP denotes the current state of the body parts 204 (in training sequence or inference, e.g., runtime call). It is possible that not all RBPs (e.g., poses of all body parts 204) are available and masking may be applied during training in order to teach the ML model to handle missing q-RBP information (e.g., missing locations, orientations or poses for any body parts 204).

A trajectory (per body part 204) can be generated by a diffusion process or an auto-regressive token generation process. The trajectories for example comprise a pose (RBP) of each body part 204 of the robot 201 for each one of a sequence of timesteps (e.g., when t₀=0 denotes a current time (where the robot 201 has the state as specified by q-RBP), for timesteps 1, 2, . . . , t—assuming here for simplicity that Group A outputs trajectory with the same temporal resolution as Group B, which is not necessary).

According to various embodiments, Group B (e.g., a transformer) outputs a trajectory per body part 204.

Optionally, Group B can also generate text that is used for Chain-of-Thought reasoning. During training sequences of actions including CoT can be generated, for example, by a person describing what they are doing as they are doing it (for teleoperated data), by labeling automatically sequences of actions based on a success criterion, or by matching the sequence of actions to more atomic actions.

CoT can improve the following aspects of the control system:
Task progress monitoring
Error detection and recovery
Dynamic task adaptation

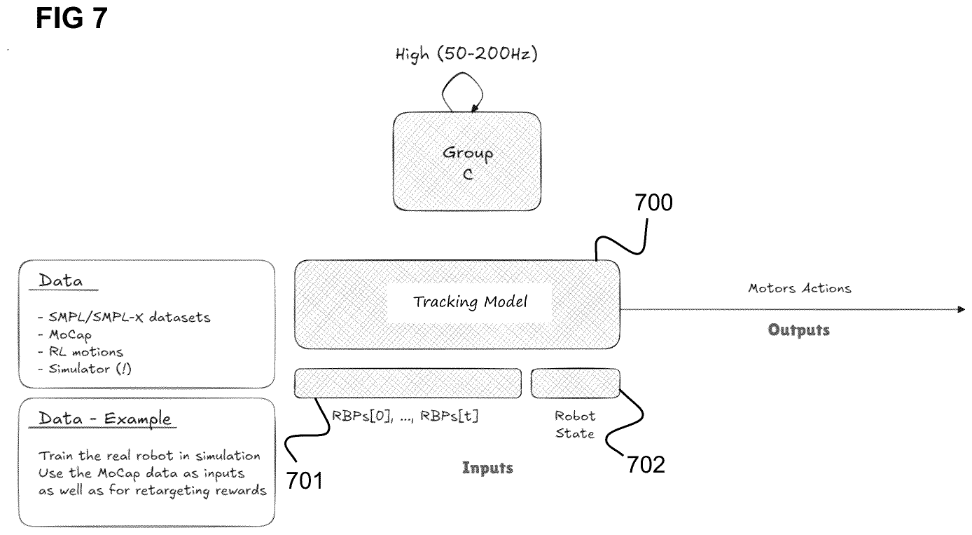

FIG. 7 illustrates an operation of a (motion) tracking model (or “tracking model” for short) 700 according to an embodiment (Group C).

The (motion) tracking model 700 controls the robot actuators 205 to have each body part 204 to follow (insofar possible) the trajectory of that body part 204 included in the output 602 of the second sub-model 600, i.e. included in the full set of body part trajectories, which the (motion) tracking model 700 receives as input 701, e.g. along with information about a current robot state 702 (e.g. joint positions for all joints).

For this, the (motion) tracking model 700 for example performs and/or supports
Robot-specific motor command generation
Real-time motion execution
Proprioceptive feedback integration
input processing for RBP sequences (e.g., pose trajectories per body part 204)
temporal position encoding (e.g., according to normalized time index, e.g., a clock signal [0,1], where for example 0 represents the starting time of a respective trajectory and 1 represents the end time (e.g., t) of the respective trajectory)
Proprioceptive state integration
Motor command generation
Real-time execution control

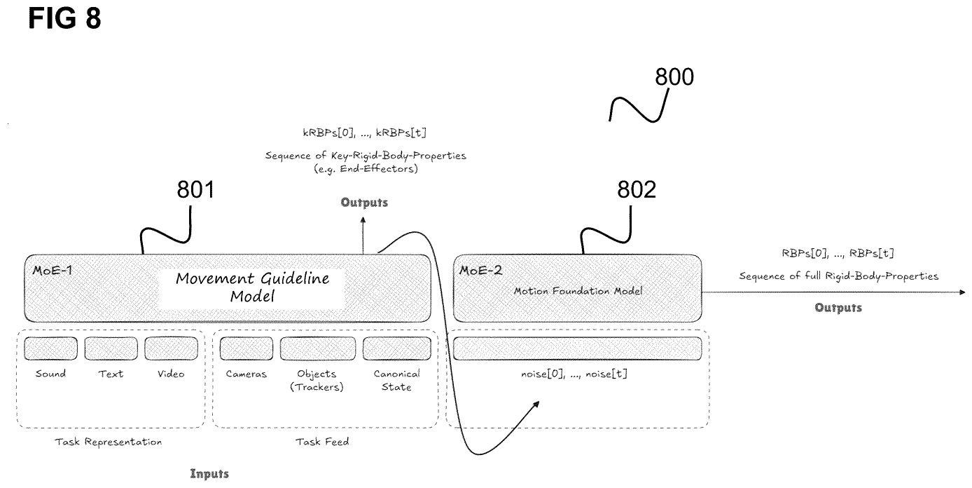

FIG. 8 illustrates an embodiment where the movement guideline model 801 and the motion model 802 are integrated together in a (e.g., task foundation) model 800, e.g., corresponding to the task foundation model 401.

The control system (in particular the ML model 300) may be trained using a multi-stage training process.

The task foundation model 304, 305 can be trained, among other inputs, on the following types of training data, e.g., datasets:
Real-world demonstration data (e.g. a human demonstrating a task in a video clip)
Simulated task execution data, specifically that obtained using Reinforcement Learning policy data
Mixed reality (AR (augmented reality)/VR(virtual reality)) data collection

Since the task foundation model 304, 305 (i.e. the part of the control system performing the functions of the task foundation model 304, 305) is robot agnostic, the training data for the task foundation model 304, 305 can be used in an original configuration (such as SMPL-X and configuration of different types of robots), e.g. a configuration for which or based on which it has been generated. However, to enhance the adaptivity, retargeted forms of the data can also be used.

For example, the training data for the movement guideline model 304 may be examples (e.g., in form of videos or specifications of trajectories of key body parts) of a human body (which the body of the robot 201 may resemble, but which may not necessarily be identical to the body of the robot). Training data for the movement guideline model 304 includes training examples of a human (or generally a composition of the body parts 204, possibly another robot) performs various tasks. In training, the movement guideline model 304 learns to generalize from these exemplary tasks.

Training data for the motion model 305 may be examples of any motions (of a composition of body parts 204 similar to the robot 201, e.g., a human, possibly represented by a body model like SMPL-X), not necessarily for performing any exemplary tasks. From that, the motion model 305 learns how complete motions (involving motion of all body parts 204) are supposed to look and thus learns to complete the key body part trajectories to the full set of trajectories. The motion model 305 can thus be seen to learn “inpainting” of body part trajectories, which it then performs in inference when the movement guideline model 304 provides it with key body part trajectories for performing a task.

The (motion) tracking model 306 can be trained, among other inputs, on the following types of training data, e.g., datasets:
training data generated in a simulator (i.e., training may comprise simulator-based (e.g., RL) training)
real-world motion sequences (i.e., training may include training to follow trajectories occurring in real-world (e.g., human) motion)
Dataset-driven learning from trajectories of body parts of human body models (e.g., SMPL, SMPL-X, MoCap). By training the (motion) tracking model 306 (which can be seen to be specific to the configuration of a robot), these trajectories can be seen to be retargeted to the specific robot.

For example, according to one embodiment, the (motion) tracking model 306 is trained (e.g., teaching the robot 201) in a simulator to follow (or “mimic”) a sequence of RBP trajectories, using reinforcement learning.

Various techniques for narrowing the sim2real (simulation to reality) gap may be included in the training of the (motion) tracking model 306 (as well as the training of the task foundation model 304, 305). Specifically, various forms of randomization, trajectory enrichment, and methods for improving the faithfulness of the simulation based on recorded real-world data may be applied.

When the foundation model 304, 305 and the (motion) tracking model 306 (in other words: group A, group B and group C or, still in other words, the A, B and C (sub-)models) have been trained, an end-to-end training (e.g., end-to-end fine-tuning) can be performed, to, illustratively speaking, tying the (sub-)models together. This can be done in a simulator, using simulation-based training and/or based on real-world recorded data. For example, when the foundation model 304, 305 and the (motion) tracking model 306 have been trained, those parts of the ML model or possibly the whole ML model also including the high-level planning layer 301 may be trained (e.g., fine-tuned) as a whole, for example using reinforcement learning, resulting in a RL policy.

As mentioned above, for training the various parts of the model, in particular the foundation model 304, 305, simulation-based training data may be used.

For generation of simulation-based training data (i.e., data collection in a simulator), a set of tasks can be defined and a simulated robot may be deployed to generate the data. In order to control the robot in a simulator a control policy (used for data generation, therefore denoted as “data generation control policy” for distinguishing it from the control policy implemented by the ML model 300) may be trained using Reinforcement Learning (RL). For example, each of multiple tasks is defined by start and end positions of relevant objects and relevant grasping points. For scalability, reward shaping may be done automatically by using techniques such as
by analyzing task structure and generating intermediate goals. Instead of hand-crafting dense rewards, useful sub-objectives may be inferred to provide the RL agent with incremental feedback that accelerates learning.
breaking to phases (e.g., approach, grasp, lift) and assigning phase-specific rewards. This structured decomposition stabilizes training and makes long-horizon behaviors easier to learn.

For this, an additional model to predict the grasping points in simulation may be used (such as Graspnet or Dexgraspnet). Running in a simulator, applying such additional models could be simpler than in real-world application, since there is perfect information regarding the objects.

It should be noted that the data generation control policy can benefit from privileged information that is not available to parts of the ML model 300 (e.g., foundation model 304, 305), such as real-world object location. Since the data generation control policy is used for data generation (in, e.g., predefined scenes), this is not an issue.

The different sim2real parameters (i.e., parameters of the physics model used by the simulator such as friction and damping) may be randomized to increase generalization capability.

Once the data generation control policy has been trained, it can be used to control a robot to solve one or more given tasks. From this, full trajectory, motor and sensor data may be collected from the robot. This gives training data that may then be used for training the ML model 300 (in particular the foundation model 304, 305).

The following may be taken into account when performing training of the data generation control policy:
there may be a randomization over tasks to generate a high amount training data (e.g., many hours of simulation) and also over the sim2real parameters of the (physics of the) robot and the environment.
runs that are not successful in the data generation may be filtered out (i.e., the data collected from them may be omitted from the training data used for the ML model 300).
For simulated camera inputs (not all simulated data must contain these), the scene may be visually augmented, e.g., by shading, changing (e.g., randomizing) colors etc.

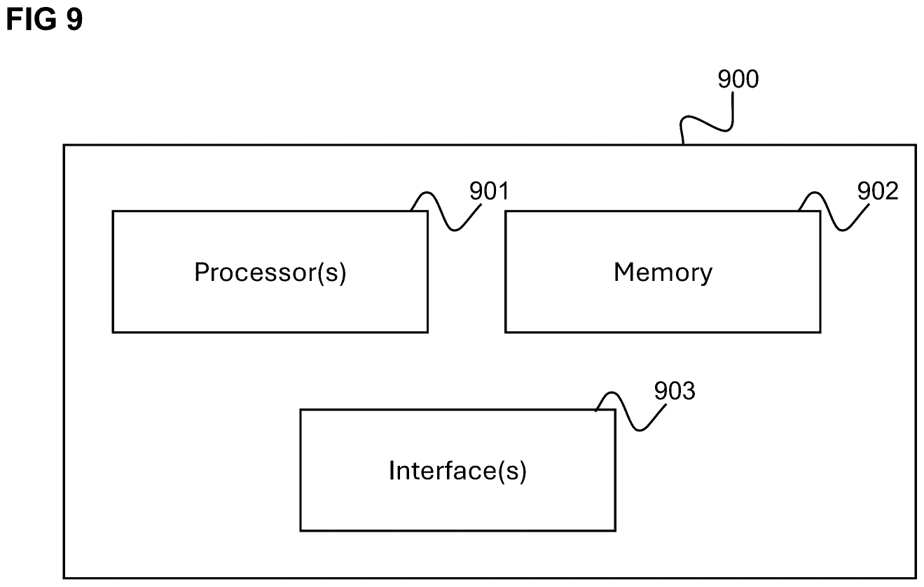

In summary, according to various embodiments, a data processing system is provided in FIG. 9.

FIG. 9 shows a data processing system 900 according to an embodiment.

The data processing system 900 may for example be or comprise a robot controller, e.g., may for example include one or more further data processing devices, e.g., for training one or more ML models. The data processing system 900 comprises one or more processors 901 and may comprise further components for data processing such as one or more of a memory 902 and one or more interfaces 903 (e.g., for user input, image data input, audio input etc.).

The one or more processors 901 are configured to control an autonomous device (e.g., a robot device such as a humanoid robot as illustrated in FIG. 2) to perform a task, wherein the device 904 has a plurality of (e.g., body) parts whose movement can be controlled by actuators, by
generating, by a motion machine-learning model (e.g., corresponding to “Group B” above), from a movement trajectory of each part of a proper subset (i.e., a subset not equal to the whole set) of the plurality of parts (i.e., from “sparse” motion information), (“full”) motion information specifying a movement trajectory of each part of the plurality of parts and
generating, by a (motion) tracking machine-learning model (e.g., corresponding to “Group C” above), actuator (e.g., motor) control signals to control the robot device to follow, with each of its parts, the movement trajectory of the part specified by the motion information.

Various embodiments address efficient control of a (complex) autonomous device, in particular a humanoid robot. However, it should be noted that all that is described herein may also be applied to other types of autonomous devices, in particular robots, such as quadruped robots etc.

According to various embodiments, according to the approach of FIG. 9, in other words, the control is achieved by having a (at least) two-stage control, wherein one stage (implemented by the motion ML model) takes “sparse” motion data (in the sense that it only specifies trajectories for few body parts, e.g. center of mass and end-effector) and performs “in-painting”, i.e. fills in trajectories for additional body parts to arrive at non-sparse motion data (but e.g. still on planning level, i.e. specifying trajectories for the various body parts). A subsequent stage (implemented by the tracking ML model) translates the output of the second stage into actuator control signals (to have the plurality of parts follow the specified trajectories).

According to various embodiments, this approach allows efficient training:
a possible ML model (e.g., corresponding to “Group A” above) generating the “sparse” motion data for example be trained using a video, e.g., of a human, performing the task.
The motion ML model can be trained using examples (e.g., shown in videos) of a composite of the plurality of parts moving (together), e.g., a human body (e.g., represented by a human body model such as SMPL-X) moving (not necessarily performing the task).
The tracking ML model can be trained using reinforcement learning, e.g. (at least partially) in a simulation

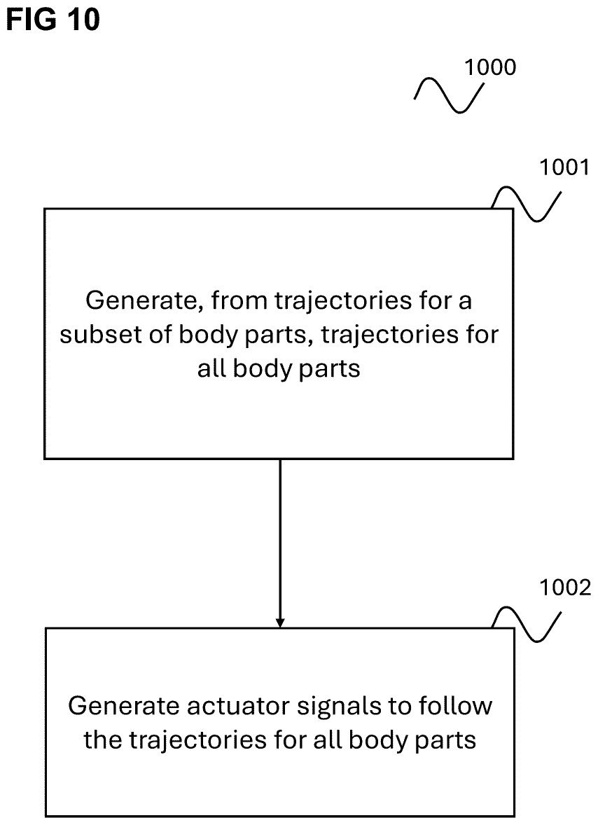

FIG. 10 shows a flow diagram 1000 illustrating a method for controlling an autonomous device (e.g., a robot device such as a humanoid robot) to perform a task, wherein the device has a plurality of (e.g., body) parts whose movement can be controlled by actuators.

In 1001, a motion machine-learning model generates, from a movement trajectory of each part of a proper subset (i.e., a subset not equal to the whole set) of the plurality of parts (i.e., from “sparse” motion information), (“full”) motion information specifying a movement trajectory of each part of the plurality of parts.

In 1002, a (motion) tracking machine-learning model generates actuator (e.g., motor) control signals to control the robot device to follow, with each of its parts, the movement trajectory of the part specified by the motion information.

Further aspects of the disclosure will be described by way of example in the following.

Example 1 is a data processing system (e.g. a robot controller or comprising a robot controller, possibly including one or more further data processing devices, e.g. for training), comprising one or more processors configured to control an autonomous device (e.g. a robot device such as a humanoid robot) to perform a task, wherein the device has a plurality of (e.g. body) parts whose movement can be controlled by actuators, by
generating, by a motion machine-learning model, from a movement trajectory of each part of a proper subset (i.e., a subset not equal to the whole set) of the plurality of parts (i.e., from “sparse” motion information), (“full”) motion information specifying a movement trajectory of each part of the plurality of parts and
generating, by a (motion) tracking machine-learning model, actuator (e.g., motor) control signals to control the robot device to follow, with each of its parts, the movement trajectory of the part specified by the motion information.

Example 2 is the data processing system of example 1, wherein the one or more processors generate the movement trajectory of each part of the proper subset of the plurality of parts by a movement guideline machine-learning model.

Example 3 is the data processing system of example 2, wherein the movement guideline machine-learning model is a device-agnostic model (a model being device agnostic may for example mean that it does not have knowledge about the kinematics of the device, e.g., of the relation between actuator control and part movement).

Example 4 is the data processing system of example 2 or 3, wherein the one or more processors train the movement guideline machine-learning model using imitation learning.

Example 5 is the data processing system of any one of examples 2 to 4, wherein the one or more processors train the movement guideline machine-learning model at least in part from demonstrations of performing a set of tasks including the task.

Example 6 is the data processing system of any one of examples 2 to 5, wherein the movement guideline machine-learning model generates the movement trajectory of each part of the proper subset of the plurality of parts from a description of the task generated by the one or more processors by a generative language model (e.g., LLM (large language model) or VLM (visual language model)).

Example 7 is the data processing system of example 6, wherein the generative language model generates the task description from a request to perform a task given at least partially in natural language (e.g., by a human user).

Example 8 is the data processing system of example 7, wherein the task is a sub-task of an overall (or “larger”) task to fulfil the request.

Example 9 is the data processing system of example 8, wherein the generative language model decomposes the overall task into multiple sub-tasks, including the task as one of the sub-tasks, and supplies a task description of each sub-task to the movement guideline machine-learning model (e.g. via an API (application programming interface) of the autonomous device; in particular, the movement guideline ML model, the motion ML model and the tracking ML model may all (or at least one or two of them) may be implemented (or run or be deployed) on the autonomous device).

Example 10 is the data processing system of any one of examples 1 to 9, wherein the motion machine-learning model generates the motion information based on knowledge (which it may have learned in training but about which it may also receive input) about motion of a body replicated by the autonomous device (e.g. of a human body in case the autonomous device is a humanoid robot). (The motion machine-learning model may be a device agnostic model.)

Example 11 is the data processing system of example 10, wherein the one or more processors train the motion machine-learning model at least in part from demonstrations of the body replicated by the autonomous device moving (e.g., including movement of all parts of the plurality of parts).

Example 12 is the data processing system of any one of examples 1 to 11, wherein the one or more processors train the motion machine-learning model at least in part from demonstrations of the autonomous device moving (e.g., including movement of all parts of the plurality of parts).

Example 13 is the data processing system of any one of examples 1 to 12, wherein the one or more processors train the motion machine-learning model using imitation learning.

Example 14 is the data processing system of any one of examples 1 to 13, wherein the tracking machine-learning model describes kinematics of the autonomous device (in particular, the tracking model may be device-specific, e.g., specific for the configuration (e.g., type of actuators, form of body parts, etc.) of the autonomous device).

Example 15 is the data processing system of any one of examples 1 to 14, wherein the tracking machine-learning model determines the actuator control signals based on proprioceptive information (e.g., feedback when moving) provided by the autonomous device.

Example 16 is the data processing system of any one of examples 1 to 15, wherein the one or more processors train the tracking machine-learning model (e.g., to follow a given trajectory) using reinforcement learning.

Example 17 is the data processing system of any one of examples 1 to 16, wherein the tracking machine-learning model operates at a higher rate than the motion machine-learning model (and, if present, the movement guideline machine-learning model). This may for example mean that it generates actuator control signals with higher rate than the motion machine-learning model (and possibly the movement guideline machine-learning model) generate points for the respective trajectories. For example, the time steps of the trajectories may be longer than the intervals at which the tracking ML model generates or updates actuator control signal values).

Example 18 is the data processing system of any one of examples 1 to 17, wherein the autonomous device is a humanoid robot.

Example 19 is the data processing system of any one of examples 1 to 18, wherein the task is a manipulation of one or more objects in an environment of the autonomous device.

Example 20 is the data processing system of example 19, wherein the proper subset of the plurality of parts includes at least part of the plurality of parts for making contact with the one or more objects (e.g., a hand or a fingertip etc.).

Example 21 is the data processing system of any one of examples 1 to 20, wherein at least one of the motion machine-learning model and the tracking model (and the movement guideline model, if it is used) has a transformer architecture.

Example 22 is the data processing system of any one of examples 1 to 21, wherein the motion machine-learning model generates the motion information using a diffusion process.

Example 23 is a method for controlling an autonomous device (e.g., a robot device such as a humanoid robot) to perform a task, wherein the device has a plurality of (e.g., body) parts whose movement can be controlled by actuators, by
generating, by a motion machine-learning model, from a movement trajectory of each part of a proper subset (i.e., a subset not equal to the whole set) of the plurality of parts (i.e., from “sparse” motion information), (“full”) motion information specifying a movement trajectory of each part of the plurality of parts and
generating, by a (motion) tracking machine-learning model, actuator (e.g., motor) control signals to control the robot device to follow, with each of its parts, the movement trajectory of the part specified by the motion information.

Example 24 is the method of example 23, comprising generating the movement trajectory of each part of the proper subset of the plurality of parts by a movement guideline machine-learning model.

Example 25 is the method of example 24, wherein the movement guideline machine-learning model is a device-agnostic model.

Example 26 is the method of example 24 or 25, comprising training the movement guideline machine-learning model using imitation learning.

Example 27 is the method of any one of examples 24 to 26, comprising training the movement guideline machine-learning model at least in part from demonstrations of performing a set of tasks including the task.

Example 28 is the method of any one of examples 24 to 27, wherein the movement guideline machine-learning model generates the movement trajectory of each part of the proper subset of the plurality of parts from a description of the task generated by a generative language model.

Example 29 is the method of example 28, wherein the generative language model generates the task description from a request to perform a task given at least partially in natural language.

Example 30 is the method of example 29, wherein the task is a sub-task of an overall task to fulfil the request.

Example 31 is the method of example 30, wherein the generative language model decomposes the overall task into multiple sub-tasks, including the task as one of the sub-tasks, and supplies a task description of each sub-task to the movement guideline machine-learning model.

Example 32 is the method of any one of examples 23 to 31, wherein the motion machine-learning model generates the motion information based on knowledge about motion of a body replicated by the autonomous device.

Example 33 is the method of example 32, comprising training the motion machine-learning model at least in part from demonstrations of the body replicated by the autonomous device moving.

Example 34 is the method of any one of examples 23 to 33, comprising training the motion machine-learning model at least in part from demonstrations of the autonomous device moving.

Example 35 is the method of any one of examples 23 to 34, comprising training the motion machine-learning model using imitation learning.

Example 36 is the method of any one of examples 23 to 35, wherein the tracking machine-learning model describes kinematics of the autonomous device.

Example 37 is the method of any one of examples 23 to 36, wherein the tracking machine-learning model determines the actuator control signals based on proprioceptive information provided by the autonomous device.

Example 38 is the method of any one of examples 23 to 37, comprising training the tracking machine-learning model using reinforcement learning.

Example 39 is the method of any one of examples 23 to 38, wherein the tracking machine-learning model operates at a higher rate than the motion machine-learning model.

Example 40 is the method of any one of examples 23 to 39, wherein the autonomous device is a humanoid robot.

Example 41 is the method of any one of examples 23 to 40, wherein the task is a manipulation of one or more objects in an environment of the autonomous device.

Example 42 is the method of example 41, wherein the proper subset of the plurality of parts includes at least part of the plurality of parts for making contact with the one or more objects.

Example 43 is the method of any one of examples 23 to 42, wherein at least one of the motion machine-learning model and the tracking model has a transformer architecture.

Example 44 is the method of any one of examples 23 to 43, wherein the motion machine-learning model generates the motion information using a diffusion process.

Example 45 is a non-transitory computer-readable medium, comprising instructions stored thereon, that when executed on a processor, perform a method for controlling an autonomous device (e.g., a robot device such as a humanoid robot) to perform a task, wherein the device has a plurality of (e.g., body) parts whose movement can be controlled by actuators, by
generating, by a motion machine-learning model, from a movement trajectory of each part of a proper subset (i.e., a subset not equal to the whole set) of the plurality of parts (i.e., from “sparse” motion information), (“full”) motion information specifying a movement trajectory of each part of the plurality of parts and
generating, by a (motion) tracking machine-learning model, actuator (e.g., motor) control signals to control the robot device to follow, with each of its parts, the movement trajectory of the part specified by the motion information.

Example 46 is the computer-readable medium of example 45, the method comprising generating the movement trajectory of each part of the proper subset of the plurality of parts by a movement guideline machine-learning model.

Example 47 is the computer-readable medium of example 46, wherein the movement guideline machine-learning model is a device-agnostic model.

Example 48 is the computer-readable medium of example 46 or 47, the method comprising training the movement guideline machine-learning model using imitation learning.

Example 49 is the computer-readable medium of any one of examples 46 to 48, the method comprising training the movement guideline machine-learning model at least in part from demonstrations of performing a set of tasks including the task.

Example 50 is the computer-readable medium of any one of examples 46 to 49, wherein the movement guideline machine-learning model generates the movement trajectory of each part of the proper subset of the plurality of parts from a description of the task generated by a

### Generative Language Model.

Example 51 is the computer-readable medium of example 50, wherein the generative language model generates the task description from a request to perform a task given at least partially in natural language.

Example 52 is the computer-readable medium of example 51, wherein the task is a sub-task of an overall task to fulfil the request.

Example 53 is the computer-readable medium of example 52, wherein the generative language model decomposes the overall task into multiple sub-tasks, including the task as one of the sub-tasks, and supplies a task description of each sub-task to the movement guideline machine-learning model.

Example 54 is the computer-readable medium of any one of examples 45 to 53, wherein the motion machine-learning model generates the motion information based on knowledge about motion of a body replicated by the autonomous device.

Example 55 is the computer-readable medium of example 54, the method comprising training the motion machine-learning model at least in part from demonstrations of the body replicated by the autonomous device moving.

Example 56 is the computer-readable medium of any one of examples 45 to 55, the method comprising training the motion machine-learning model at least in part from demonstrations of the autonomous device moving.

Example 57 is the computer-readable medium of any one of examples 45 to 56, the method comprising training the motion machine-learning model using imitation learning.

Example 58 is the computer-readable medium of any one of examples 45 to 57, wherein the tracking machine-learning model describes kinematics of the autonomous device.

Example 59 is the computer-readable medium of any one of examples 45 to 58, wherein the tracking machine-learning model determines the actuator control signals based on proprioceptive information provided by the autonomous device.

Example 60 is the computer-readable medium of any one of examples 45 to 59, the method comprising training the tracking machine-learning model using reinforcement learning.

Example 61 is the computer-readable medium of any one of examples 45 to 60, wherein the tracking machine-learning model operates at a higher rate than the motion machine-learning model.

Example 62 is the computer-readable medium of any one of examples 45 to 61, wherein the autonomous device is a humanoid robot.

Example 63 is the computer-readable medium of any one of examples 45 to 62, wherein the task is a manipulation of one or more objects in an environment of the autonomous device.

Example 64 is the computer-readable medium of example 63, wherein the proper subset of the plurality of parts includes at least part of the plurality of parts for making contact with the one or more objects.

Example 65 is the computer-readable medium of any one of examples 45 to 64, wherein at least one of the motion machine-learning model and the tracking model has a transformer architecture.

Example 66 is the computer-readable medium of any one of examples 45 to 65, wherein the motion machine-learning model generates the motion information using a diffusion process.

It should be noted that the examples described in context of the data processing system are analogously valid for the method and the non-transitory computer-readable medium and vice versa.

While the above descriptions and connected figures may depict components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all examples included herein.

1. A data processing system, comprising one or more processors configured to control an autonomous device to perform a task, wherein the device has a plurality of parts whose movement can be controlled by actuators, by
generating, by a motion machine-learning model, from a movement trajectory of each part of a proper subset of the plurality of parts, motion information specifying a movement trajectory of each part of the plurality of parts; and
generating, by a tracking machine-learning model, actuator control signals to control the robot device to follow, with each of its parts, the movement trajectory of the part specified by the motion information.

2. The data processing system of claim 1, wherein the one or more processors generate the movement trajectory of each part of the proper subset of the plurality of parts by a movement guideline machine-learning model.

3. The data processing system of claim 2, wherein the movement guideline machine-learning model is a device-agnostic model.

4. The data processing system of claim 2, wherein the one or more processors train the movement guideline machine-learning model using imitation learning.

5. The data processing system of claim 2, wherein the one or more processors train the movement guideline machine-learning model at least in part from demonstrations of performing a set of tasks including the task.

6. The data processing system of claim 2, wherein the movement guideline machine-learning model generates the movement trajectory of each part of the proper subset of the plurality of parts from a description of the task generated by the one or more processors by a generative language model.

7. The data processing system of claim 6, wherein the generative language model generates the task description from a request to perform a task given at least partially in natural language.

8. The data processing system of claim 7, wherein the task is a sub-task of an overall task to fulfil the request.

9. The data processing system of claim 8, wherein the generative language model decomposes the overall task into multiple sub-tasks, including the task as one of the sub-tasks, and supplies a task description of each sub-task to the movement guideline machine-learning model.

10. The data processing system of claim 1, wherein the motion machine-learning model generates the motion information based on knowledge about motion of a body replicated by the autonomous device.

11. The data processing system of claim 10, wherein the one or more processors train the motion machine-learning model at least in part from demonstrations of the body replicated by the autonomous device moving.

12. The data processing system of claim 1, wherein the one or more processors train the motion machine-learning model at least in part from demonstrations of the autonomous device moving.

13. The data processing system of claim 1, wherein the one or more processors train the motion machine-learning model using imitation learning.

14. The data processing system of claim 1, wherein the tracking machine-learning model describes kinematics of the autonomous device.

15. The data processing system of claim 1, wherein the tracking machine-learning model determines the actuator control signals based on proprioceptive information provided by the autonomous device.

16. The data processing system of claim 1, wherein the one or more processors train the tracking machine-learning model using reinforcement learning.

17. The data processing system of claim 1, wherein the tracking machine-learning model operates at a higher rate than the motion machine-learning model.

18. The data processing system of claim 1, wherein the autonomous device is a humanoid robot.

19. A method for controlling an autonomous device to perform a task, wherein the device has a plurality of parts whose movement can be controlled by actuators, by
generating, by a motion machine-learning model, from a movement trajectory of each part of a proper subset of the plurality of parts, motion information specifying a movement trajectory of each part of the plurality of parts; and
generating, by a tracking machine-learning model, actuator control signals to control the robot device to follow, with each of its parts, the movement trajectory of the part specified by the motion information.

20. A non-transitory computer-readable medium, comprising instructions stored thereon, that when executed on a processor, perform a method for controlling an autonomous device to perform a task, wherein the device has a plurality of parts whose movement can be controlled by actuators, by
generating, by a motion machine-learning model, from a movement trajectory of each part of a proper subset of the plurality of parts, motion information specifying a movement trajectory of each part of the plurality of parts; and
generating, by a tracking machine-learning model, actuator control signals to control the robot device to follow, with each of its parts, the movement trajectory of the part specified by the motion information.
